(19) United States
(12) Patent Application Publication
(10) Pub. No.: US 2019/0063960 A1
(43) Pub. Date: Feb. 28, 2019

(54) MEASUREMENT SYSTEM

(71) Applicant: Fibercore Limited, Chilworth (GB)

(72) Inventor: Rogerio Tadeu Ramos, Chilworth (GB)

(21) Appl. No.: 16/110,002

(22) Filed: Aug. 23, 2018

(30) Foreign Application Priority Data
Aug. 30, 2017 (GB) 1713904.9

(51) Int. Cl. G01D 5/353; G02B 6/02

(52) U.S. Cl. CPC G01D 5/35335; G01D 5/35316; G02B 6/02042; G01D 5/3538; G02B 6/02076; G02B 6/02395

(57) ABSTRACT

A measurement system may be enabled to detect properties within an enclosure based on information detected using optical fiber sensors. The measurement system may include an enclosure having at least one wall with an inside surface and an outside surface; at least one silica-based optical fiber comprising at least one functional optical fiber core and at least one cladding layer; at least one optical fiber interrogation member; at least one transducer arranged to output energy; a controller; and a processing element configured to communicate with the optical fiber interrogator and the controller. The silica-based optical fiber is associated with a wall of the enclosure. The controller is configured to control the optical fiber interrogator and the transducer. The processing element is configured to process information from the optical fiber interrogation member.

This application claims the benefit of GB Application 1713904.9, filed Aug. 30, 2017. The entire content of GB Application 1713904.9 is incorporated herein by reference.

### TECHNICAL FIELD

There is provided a measurement system, particularly a measurement system for enclosures using optical fibers as a sensing element.

### BACKGROUND

Obtaining data about the interior properties of a system, such as a pipeline or an enclosure, allows for effective monitoring of key parameters of the system. These parameters may include flow rate, pressure and composition relating to a fluid within the pipeline or enclosure. Effective monitoring requires the provision of real-time feedback of such parameters, that may be inferred from detected interior properties such as acoustic, sonic or vibration energy patterns.

Additional examples of monitoring include, monitoring the position or movement of materials within the pipeline or enclosure; and to monitor the mixing, interaction or reaction of materials within the pipeline or enclosure. These materials may take the form of inanimate parts or objects, or they may be living organisms. The system may be used to monitor activity within a pipe, a vessel, a machine enclosure, a process chamber, a vat, a mixer or a room, to give a few examples. In instances where the system is used for monitoring activity within a pipe, it may be desirable to monitor the flow of fluids within the pipe, such as flow rate, velocity or composition.

Activity within a pipeline or enclosure can generate, emit, scatter, refract or reflect acoustic, sonic or vibration energy. Such energy can be detected by sensors placed at or embedded in the walls of the enclosure. The more sensors available, the better is the ability to interpret the signals in a useful way, as more information becomes available.

### SUMMARY

In accordance with a first aspect of the present disclosure there is provided a measurement system comprising:

an enclosure having at least one wall with an inside surface, and an outside surface; at least one silica-based optical fiber comprising at least one functional optical fiber core and at least one cladding layer; at least one optical fiber interrogation member; at least one transducer arranged to output energy; a controller; and a processing element arranged to communicate with the optical fiber interrogator and the controller; wherein the silica-based optical fiber is associated with a wall of the enclosure; wherein the controller is arranged to control the optical fiber interrogator; wherein the controller is further arranged to control the transducer; wherein the processing element is arranged to process information from the optical fiber interrogation member.

There is provided a system wherein at least one silica-based optical fiber is used as a sensing element within an enclosure, which may optionally be a chamber with one or a plurality of apertures. The optical fiber is comprised primarily of silica and may comprise at least one functional core. The optical fiber also may comprise a cladding layer, wherein the fiber diameter is the diameter of the outermost cladding layer. In additional examples, the optical fiber comprises a second cladding layer. In other examples s, an optical fiber comprising multiple cladding layers is conceivable.

The use of optical fibers as sensors is advantageous because of their small size, low weight and the ability to combine many sensors in one or a small number of fibers. Another advantage is the ability to provide distributed measurements along the fiber, meaning that the whole length of the fiber can be used as sensors or sensor array. The optical sensors can be based on a variety of techniques such as Rayleigh scattering, Brillouin scattering, Raman scattering, interferometric techniques, attenuation or intensity variation techniques. The optical fiber interrogation member may comprise an optical fiber sensor instrumentation (OF SI) used to interrogate the optical fiber sensors. The optical fiber interrogation member is arranged to send and receive an optical signal in such a way that the signal can be detected and transformed into useful information. Optionally the signal received by the optical fiber interrogation member from the optical fiber may be in the form of backscatter through techniques such as Rayleigh scattering, Brillouin scattering, Raman scattering, interferometric techniques, attenuation or intensity variation techniques.

The level of backscatter may be used to inform the system of the internal properties within the enclosure. The system further comprises a processing element arranged to communicate with the optical fiber interrogation member, wherein the processing element processes data relating to the light received by the optical fiber interrogation member. The processing element is further arranged to communicate with a controller. The controller is arranged to control the optical fiber interrogation member, such that the controller controls the interrogation of the optical fiber by the optical fiber interrogation member. The processing element is further arranged to communicate with the controller and may optionally provide instructions to the controller to control the interrogation of the optical fiber.

The optical fiber interrogation member, the processing element and the controller may be comprised within a distributed acoustic sensing (DAS) or distributed vibration sensing (DVS) instrumentation. Such instrumentation normally uses Rayleigh scattering and it could be used for the purpose of the present disclosure.

The advantage of the present system is that the whole length of the optical fiber can be used as a sensor. As such the system can sense thousands of meters of fiber and is configurable at the DAS or DVS instrumentation at one end of the fiber. The system normally works through the optical fiber interrogation member sending one or more pulses of light in the form of an optical signal, normally in the infrared spectrum, into an optical fiber. Some of the light is scattered by the material of the optical fiber is directed backwards to the DAS or DVS instrumentation. The time the signal takes to return to the DAS or DVS instrumentation provides the information on the distance within the optical fiber where the scattering originated. The properties of the optical signal, such as its phase, may then be used to infer vibration, strain or temperature properties surrounding the optical fiber. The DAS or DVS instrumentation can be configured to provide thousands of measurements along the length of the optical fiber.

The controller of the present system is also arranged to control a transducer comprised within the system, wherein the controller is arranged to actuate the transducer. Optionally the processing element is arranged to provide instructions to the controller to actuate the transducer. Upon actuation, energy emission from the transducer causes a change in the backscatter properties of the optical fiber, which results in a change to the light received by the optical fiber interrogation member. The change in light received by the optical fiber interrogation member is interpreted by the processing element and is used to infer the properties of the enclosure. Default properties of the system may be known by the processing element, so as to enable the processing element to detect a departure from the default properties.

A model or algorithm can be used within the processing element to assist the interpretation of the signals received by the optical fiber interrogation member. A model or algorithm can allow the processing element to use known properties or predicted behaviour of what is inside the enclosure and combine this with the signals detected to provide better measurements. The modelling can be assisted by finite element analysis (FEA) techniques and/or analytical or parametric models. Artificial intelligence (AI) techniques can also be used in order to allow the system to “learn” from experience.

The use of a model, algorithm and/or effective calibration can allow the system to distinguish or separate the effects of vibrations or signals originating from the enclosure from both the effects of vibrations or signals from the surrounding environment and/or from vibrations or signals within the enclosure. This can be very valuable as effects such as tube waves or chamber resonances, as well as noise from the surrounding area, can have detrimental effects on the quality of the measurement undertaken by a system without this capability. In the case of a flow measurement, noise originating downstream or upstream from the point of measurement can also be an issue that can be minimised by the use of a model or algorithm by the processing element and/or effective calibration. Any such additional noise could, however, also be used as a source of information in the present disclosure, and be processed accordingly.

The processing element may be comprised within a computer, and can be used to process information from the optical fiber interrogation member received from the optical fiber sensors. This information can be combined with information from the model and/or algorithm and/or from effective calibration to accurately interpret signals received by the optical fiber interrogation member and provide a measurement with a desired accuracy and/or sensitivity.

The optical fiber diameter may be between 50 μm and 250 μm. At least a portion of the optical fiber may comprise at least one coating layer.

The optical fiber diameter comprises the optical fiber core and the optical fiber cladding layers. The outer diameter of the fiber may be between 50 μm and 250 μm. The fiber diameter is customised to the specific application of the system. The application may also require that the optical fiber of the system further comprises a coating layer. This coating layer may act as protection from harsh applications. The coating layer may also act to provide a sensing medium to augment the sensing properties of the optical fiber. In instances wherein the coating layer may act to protect the optical fiber, the coating layer may comprise an elastic modulus in the range from 0.5 to 500 MPa. The coating material may also comprise in at least a portion, radiation-cured coating materials including but restricted to epoxy-acrylates, urethane-acrylates, silicone rubbers (including rtv silicones), polyimides and epoxies. In instances wherein the coating layer may act to augment the sensing properties of the optical fiber, the coating layer comprise in part at least one selected from: a magnetostrictive material, an electrostrictive material, a piezoelectric material or a polarisation sensitive material. The coating material may comprise polymers loaded with particles of a magnetostrictive material, an electrostrictive material, a piezoelectric material or a polarisation sensitive material.

The optical fiber may comprise at least one optical grating.

In some examples, the optical fiber comprises at least one optical grating, such as a fiber Bragg grating (FBG). Optionally the presence of an optical grating may increase the level of backscatter within the fiber.

The optical fiber may include one selected from the range: single core optical fiber; single mode optical fiber; multimode optical fiber; multicore optical fiber.

In some examples, the at least one functional core of the optical fiber is a single mode optical fiber core. In other examples, the at least one functional core of the optical fiber is a multimode optical fiber core.

In accordance with some examples of the first aspect of the present disclosure, the optical fiber is located in at least one location selected from the range of: adjacent the outside surface of the enclosure wall; adjacent the inside surface of the enclosure wall; between the inside surface of the enclosure wall and the outside surface of the enclosure wall; within the cavity of the enclosure.

It is possible to embed the optical fiber in the wall of the enclosure. This can be facilitated if a composite material is used at the wall because it can be relatively easy to embed optical fibers into composite material. Some composite materials use fibers, such as glass or carbon fibers, in a resin matrix where optical fibers can be embedded during fabrication.

It is important to place the optical fiber in such a way that it assists a particular type of detection by its position and placement pattern. The optical fiber can be laid in different patterns proposed here: dense wrap, sparse wrap, round coil, longitudinal elongated coil, transverse elongated coil, longitudinal ripple, transverse ripple. The coil patterns tend to bring better resolution. The elongated patterns tend to integrate the measure over the direction of the elongation. The rippled patterns tend to provide some of both previous characteristics, but they also help to cope with strain issues at the enclosure wall.

In accordance with some examples of the first aspect of the present disclosure, the transducer is located in at least one location selected from the range of: adjacent the outside surface of the enclosure wall; adjacent the inside surface of the enclosure wall; between the inside surface of the enclosure wall and the outside surface of the enclosure wall; within the cavity of the enclosure.

The system may further comprise at least one probe of known properties. In some examples, the probe is arranged to move within the enclosure. The probe may be used for calibration of the system.

It may be advantageous to place at least one probe of known properties within the enclosure during calibration. The probe can be an object of a given material or shape, or a transducer able to emit a signal, such as a piezoelectric transducer emitting acoustic or vibration signals, for example. The probe or probes can be moved or scanned in the enclosure to provide several calibration sets. An array of probes can also be used.

During the process of calibration, certain situations or configurations can be simulated in order to provide the conditions needed for the calibration. In some cases, it will be advantageous to place certain materials, fluids or gasses in the enclosure during calibration. In some cases, a movement of flow of those materials, fluid or gases, or even a mixture of those materials, fluids or gasses can also be introduced as probes of known properties into the enclosure to aid the calibration process.

In some examples, the default properties of the enclosure, which are used by the processing element to detect a change in the default properties of the enclosure, are calibrated through the use of at least one probe with known properties. The probe may be located within at least one region of the enclosure. In some examples, the probe is arranged to move within at least one region of the enclosure. In some examples, the probe is an active probe. In alternative examples, the probe is a passive probe. The probe can either be passive or active, and/or there can be more than one type of probe used. A passive probe may comprise a probe that simulates the shape and material of at least part of the intended contents of the enclosure. For example, if the enclosure is used to detect the movement of aqueous solutions in air, the passive probe could be made of aqueous gel, or if the aim of the system is to detect the presence of solids within liquids, the passive probe could be made of the desired solid to be detected. In examples wherein the probe is an active probe, the active probe may comprise a transducer to emit signal at different locations within the enclosure for the purpose of calibration. The use of an active probe such as the one described can be particularly useful if the contents of the enclosure are capable of emitting an energy signal, for instance bubbles moving at speed.

The controller may be further arranged to control a process in which the enclosure is part.

In some examples, the controller is arranged to not only control the optical fiber sensor interrogation member and the transducer, but is also linked to a process in which the enclosure and the system are a part. Optionally such a process may be the provision of water to an enclosure such as a pipe. In such an optional example, the controller may be arranged to control the provision of water to the pipe, wherein provision of water to the pipe is based upon interpretations by the processing element of signals received by the optical fiber interrogation member.

The transducer may include one selected from the range: acoustic, vibration, electric, magnetic, electromagnetic, optical, mechanical.

In some cases, there may not be enough signal generated inside the enclosure to be interpreted. Transducers can be placed at the enclosure walls in order to generate signal needed for the interpretation. Such transducers can be acoustic, vibration, electric, magnetic, electromagnetic, optical, or mechanical. The operation of the transducers can be performed during operation and/or calibration of the system. The signals to be interpreted can be scattered, reflected, reflected, or interacted in any way with the contents of the enclosure. The signals can also interact with the enclosure itself and/or the environment.

The processing element may be enabled to calculate at least one selected from the range: flow rate, flow velocity, volume fraction, filling level, filling rate, emptying rate, mixing rate, uniformity, distribution, position, movement of enclosure contents, state of matter of enclosure contents, chemical reaction speed, chemical reaction rate, start of a process, cessation of a process, failure, creep, distortion, break of materials, rupture of materials, bubbling, fizzing, outgassing, leaks.

It is possible also to use information from additional sensors that are not optical fiber based in order to improve the measurement. Those sensors can be placed at the enclosure, at the vicinity of the enclosure or at other stages of processes involving the enclosure operation. Any measurement by the system can include flow rate, flow velocity, volume fraction, filling level, filling rate, emptying rate, mixing rate, uniformity, distribution, position, movement of enclosure contents, state of matter of enclosure contents, chemical reaction speed, chemical reaction rate, start of a process, cessation of a process, failure, creep, distortion, break of materials, rupture of materials, bubbling, fizzing, outgassing or leaks.

The enclosure may be composed of material comprising at least in-part one selected from the range: metal, plastic, rubber, ceramic, mineral, geomaterial, organic matter, polymer, composite material.

In optional examples the enclosure may comprise a process vessel for use in the food industry. Examples of applications of the present system with such an enclosure include the monitoring of the addition of ingredients and control of mixing processes.

In additional optional examples the enclosure may comprise a process vessel for use in the oil and gas industry. In the context of the present disclosure, a pipe is considered as an enclosure. Possible examples of applications of the present system with such an enclosure include monitoring of multiphase flows and the control of processing vessels in refineries.

In additional further examples, the enclosure of the present disclosure may be a room or a building. Potential examples of applications of the present system with such an enclosure include monitoring of the movement of material and people in warehouses or factories, mainly if there are health and safety concerns.

In accordance with a second aspect of the present disclosure, there is provided an optical fiber package enabled to be used within a measurement system as hereinbefore described.

### BRIEF DESCRIPTION OF THE DRAWINGS

Specific examples will now be described by way of example only, and with reference to the accompanying drawings.

FIG. 1 shows a diagram of a measurement system in accordance with a first aspect of the present disclosure.

FIG. 2 shows a diagram of a measurement system from FIG. 1 comprising different optical fiber arrangements.

FIG. 3 shows a diagram of a measurement system from FIG. 1 comprising a probe.

### DETAILED DESCRIPTION

Presently available technology provides for the incorporation of sensors within a pipeline or conduit, wherein sensors used comprise optical fibers. Examples of such systems are disclosed in GB 2,399,412 A and WO 2012/114067 A1, and are primarily used to detect vibration or acoustic energy changes related to fluid flow.

Problems with the currently available technology include a lack of sensitivity, robustness and detection over long distances.

It is therefore desirable to provide a measurement system that circumvents the failures of the current technology by providing a system with improved sensitivity, improved robustness to harsh applications, and improved performance over long distances.

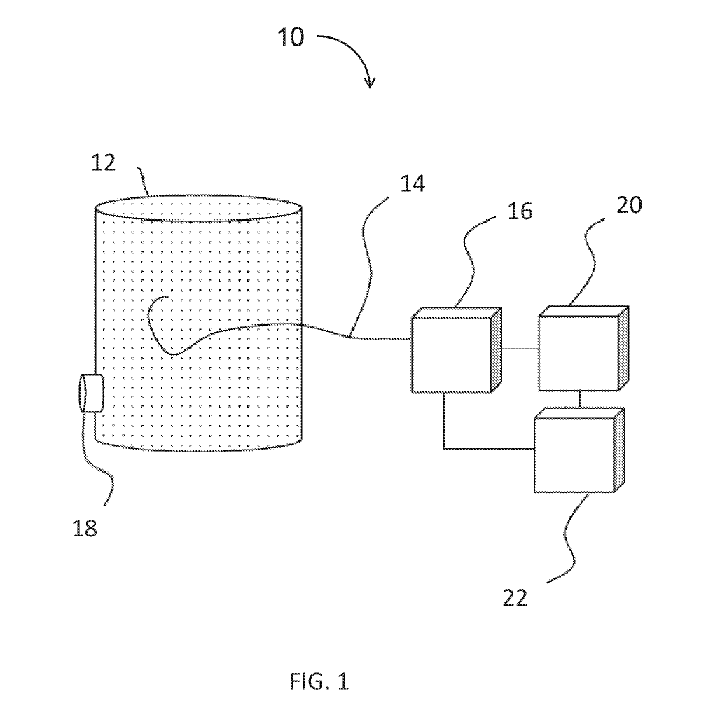

Referring to FIG. 1, one possible application of the present disclosure is shown. As can be seen the measurement system 10 comprises an enclosure 12 and an optical fiber 14 positioned adjacent the enclosure 10. The optical fiber 14 is arranged to provide and receive optical signals from the optical fiber interrogation member 16. A transducer 18 is located at the wall of the enclosure 12. The system further comprises a controller 20 enabled to control the optical fiber interrogation member 16 and/or the transducer 18. The processing element 22 is arranged to provide instructions to the controller 20 and to interpret signals received by the optical fiber interrogation member 16.

The measurement system according to FIG. 1 calculates flow measurements, where the enclosure is a type of pipe or flow tank. In this case, the enclosure can have two openings, one to let fluids in and the other to let fluids out of the enclosure. This can be particularly useful for measurement in multi-phase flows where there is a mixture of fluids, for example: water, oil and/or gas. The movement of the different fluids can generate vibration and/or small pressure fluctuations that could be detected as acoustic signals. The movement of gas bubbles could generate these signals, which are optionally detected by the system. The transducer 18 is used to generate signals that are reflected, refracted and/or scattered by the interface between fluids. The properties of the reflection, refraction and/or scattering of the signals is dependent upon the properties within the pipe, for instance the fluid flow rate, or the presence of debris. These properties affect the scattering characteristics of the optical fiber 14 and this is detected by the optical fiber interrogation member 16 and interpreted by the processing element 22. The change in the backscatter of the optical fiber 14 detected by the optical fiber interrogation member 16 is used to infer changes in the internal properties by the processing element 22. Depending upon the changes to the properties detected, these changes may cause the processing element 22 to instruct the controller 20 to control a change in the process to which the system is linked. In the case of the example shown in FIG. 1, the controller 20 may be instructed to change the level of flow of fluid to the enclosure 12 which takes the form of a pipe.

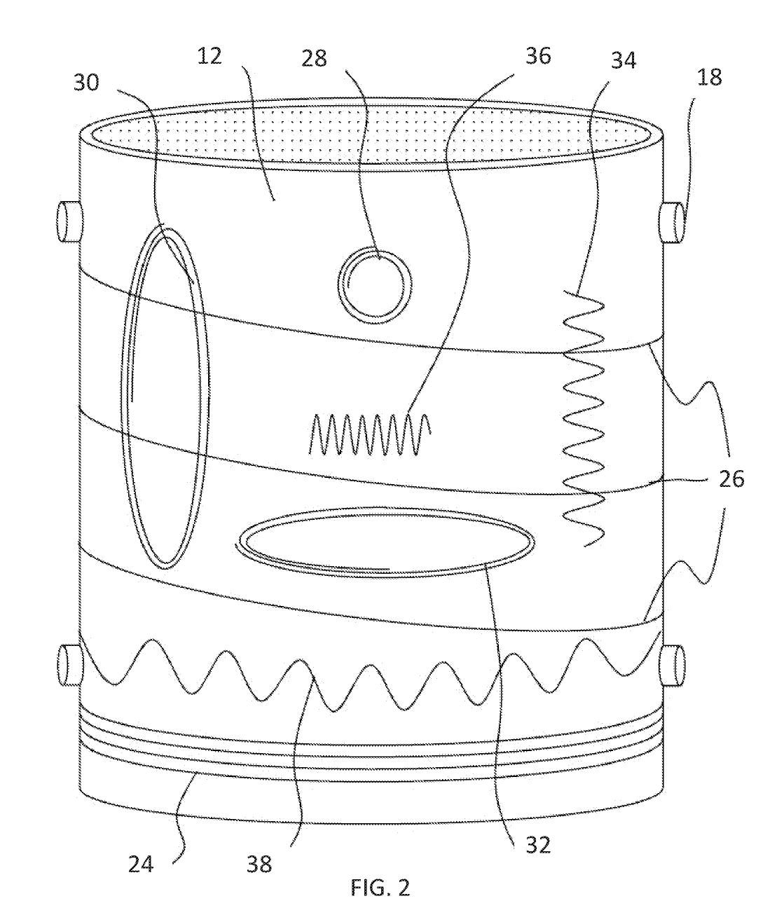

The capabilities of the system can depend upon the arrangement of the optical fibers associated with the walls of the enclosure. FIG. 2 shows examples of different arrangements of the optical fiber of the system. The examples of optical fiber arrangements shown are dense wrap 24, sparse wrap 26, round coil 28, longitudinal elongated coil 30, transverse elongated coil 32, longitudinal ripple 34, transverse ripple 36, ripple wrap 38. The different optical fiber arrangements may optionally be connected to others by continuation of the optical fiber. FIG. 2 also illustrates the use of transducer 18 at the wall of the enclosure. Transducers 18 is used to generate signals detected through their effect on the scattering of light signals within the optical fiber arrangements 24 to 38.

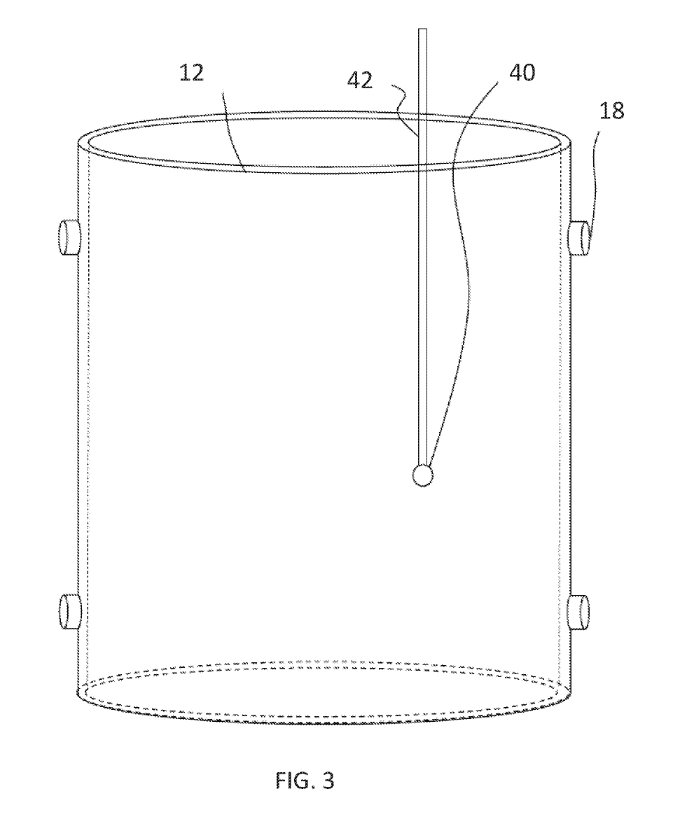

In optional examples, a probe may be used during operation and/or calibration of the system. An example of such an example is shown in FIG. 3. In this example, the probe 40 comprises a material of known properties and is introduced to the enclosure. Transducers 18 are used to emit signals that are to be detected and interpreted by the system. Interaction of the signals with the probe 40 causes a change in the signals detected by the system when compared to the signals detected without probe 40 present. The changes may be used to calibrate the system in order to improve detection of the desired materials and/or properties. Optionally probe 40 may be moved within the enclosure in order to simulate movement of the desired material within the enclosure. Such movement may be controlled, in order to calibrate the system to detect speed or positioning of a desired material. The probe 40 may be placed, held, or moved using a support 42.

Such smart enclosures could take the form of smart pipes that could be used in pipelines, processing plants or even in oil and/or gas wells. This would find applications related to oil and/or gas, power, nuclear, processing plants and/or equipment.

It will be appreciated that the above described examples are given by way of example only and that various modifications thereto may be made without departing from the scope of the disclosure as defined in the appended claims. For example, other possible applications include the monitoring of rooms, flats, houses and/or buildings, wherein the enclosure comprises a room or building. The system may be used within hospitals, nursing homes or any location were vulnerable people are housed, either by disability or by age, such as the very old and the very young people. In locations where patients or residents are vulnerable, it would be desirable to have an alarm system that detects unusual activities such as a person having a fall, shouting for help, someone struggling to open a door, something dropping on the floor or even the lack of usual activities. The system would be able to provide information of the location of an anomalous event and the nature of the event so that timely and correct assistance can be provided.

What is claimed is:

1. A measurement system comprising:
an enclosure having at least one enclosure wall with an inside surface and an outside surface;
at least one silica-based optical fiber comprising at least one functional optical fiber core and at least one cladding layer;
at least one optical fiber interrogation member;
at least one transducer arranged to output energy;
a controller; and
a processing element arranged to communicate with the optical fiber interrogator and the controller;
wherein the silica-based optical fiber is associated with a wall of the enclosure;
wherein the controller is configured to control the optical fiber interrogator;
wherein the controller is further configured to control the transducer; and
wherein the processing element is configured to process information from the optical fiber interrogation member.

2. The measurement system according to claim 1, wherein the silica-based optical fiber diameter is between 50 μm and 250 μm.

3. The measurement system according to claim 1, wherein at least a portion of the silica-based optical fiber comprises at least one coating layer.

4. The measurement system according to claim 1, wherein the optical fiber measurement system comprises at least one selected from the group consisting of: an optical grating; a Fiber Bragg Grating; distributed acoustic sensing instrumentation; distributed vibration sensing instrumentation; or artificial intelligence implementation configured to allow the measurement system to learn from experience.

5. The measurement system according to claim 1, wherein the silica-based optical fiber is one selected from the group consisting of: single core optical fiber; single mode optical fiber; multimode optical fiber; or multicore optical fiber.

6. The measurement system according to claim 1, wherein the silica-based optical fiber is located in at least one location selected from the group consisting of: adjacent the outside surface of the enclosure wall; adjacent the inside surface of the enclosure wall; between the inside surface of the enclosure wall and the outside surface of the enclosure wall; or within a cavity of the enclosure.

7. The measurement system according to claim 1, wherein the transducer is located in at least one location selected from the group consisting of: adjacent the outside surface of the enclosure wall; adjacent the inside surface of the enclosure wall; between the inside surface of the enclosure wall and the outside surface of the enclosure wall; or within a cavity of the enclosure.

8. The measurement system according to claim 1, wherein the system further comprises at least one probe of known properties.

9. The measurement system according to claim 8, wherein the probe is configured to move within the enclosure.

10. The measurement system according to claim 8, wherein the probe is a passive probe or an active probe.

11. The measurement system according to claim 8, wherein the probe is used for calibration of the system.

12. The measurement system according to claim 1, wherein the controller is further configured to control a process in which the enclosure is part.

13. The measurement system according to claim 1, wherein the transducer is one selected from the group consisting of: acoustic, vibration, electric, magnetic, electromagnetic, optical, or mechanical.

14. The measurement system according to claim 1, wherein the processing element is configured to calculate at least one selected from the group consisting of: flow rate, flow velocity, volume fraction, filling level, filling rate, emptying rate, mixing rate, uniformity, distribution, position, movement of enclosure contents, state of matter of enclosure contents, chemical reaction speed, chemical reaction rate, start of a process, cessation of a process, failure, creep, distortion, break of materials, rupture of materials, bubbling, fizzing, outgassing, or leaks.

15. The measurement system according to claim 1, wherein the enclosure is composed of material comprising at least in-part one selected from the group consisting of: metal, plastic, rubber, ceramic, mineral, geomaterial, organic matter, polymer, or composite material.

16. An optical fiber package configured to be used within a measurement system according to claim 1.
